(19) United States
(12) Patent Application Publication
(10) Pub. No.: US 2015/0128465 A1
(43) Pub. Date: May 14, 2015

(54) EASILY REMOVED IDENTIFICATION BANDS

(71) Applicant: Johnson & Johnson Consumer Companies, Inc., Skillman, NJ (US)

(72) Inventor: Shannon Montulet, Kendall Park, NJ (US)

(73) Assignee: Johnson & Johnson Consumer Companies, Inc., Skillman, NJ (US)

(21) Appl. No.: 14/075,450

(22) Filed: Nov. 8, 2013

(51) Int. Cl. G09F 3/00

(52) U.S. Cl. CPC G09F 3/005
USPC 40/633

(57) ABSTRACT

A band for encircling a body part includes a strip of substantially non-stretchable material having a single weakened region comprising a removable strip of the band. The strip of substantially non-stretchable material has two ends having associated therewith one or more closure mechanisms to securely attach the two ends together. The removable strip is at least partially defined by a pair of lines of weakness separated by a gap of between about 2 and about 15 mm. A method of using such a band includes the steps of encircling a body part, securely fastening the ends together, and after use gripping the removable strip of the first side edge of the band and pulling the removable strip to fracture the band along the lines of weakness and to separate the removable strip from the band and removing the band.

### FIELD OF THE INVENTION

The present invention relates to bands, such as identification and security bands, that are easily removable from around an appendage about which they are affixed. More particularly, the invention relates to identification bands such as hospital identification bands and security wristbands.

### BACKGROUND OF THE INVENTION

Identification and security bands are bands that encircle a human body part, such as a wrist or ankle, or even other animal body parts, such as in a veterinary practice. They are made from a variety of materials depending on the purpose. Two common bands are hospital bands and event/security wristbands. Hospital bands are a commonly used safety device for identifying patients undergoing medical care. Event/security wristbands are often given to attendees at events such as music festivals, amusement parks, and pools, and act as an access control measure.

Conventionally, a wristband is wound in a ring shape placed around a wrist or an ankle by fastening both ends of the band together. Various closures are utilized fasten the ends. In broad terms, these closures may be described as either mechanical or adhesive.

Most wristbands are only needed for short periods of time, such as a brief hospital stay, or a day at a concert or park. Once the wristband has served its purpose, it is usually removed by the wearer. Whether the method of closure is mechanical or adhesive, the wristband is constructed to be difficult or impossible to remove without damaging it. For wristbands utilizing mechanical closures, a specialized tool is often required to break the mechanical fastener.

In one example, Newman et al., U.S. Pat. No. 6,349,493 purports to disclose wristband is specifically constructed for use in amusement parks having amusement rides or exhibits. The wristband includes a strip of waterproof paper which is tear resistant but will tear completely if subjected to a force which would jeopardize the safety of the wearer in an amusement park environment.

When the method of closure is adhesive, the user often removes the wristband using sharp objects such as knives or scissors to cut through the band. This process risks injury to the user if the sharp object contacts the user's skin.

In summary, temporary wristbands are used for identification or as an access control measure. Removal of the bands after use often requires specialized tools or risk of harm to the user. What is needed is a wristband constructed for easy, destructive removal.

### SUMMARY OF THE INVENTION

Surprisingly, we have found a novel way to improve the ease with which a temporary wristband may be removed. In one aspect of the invention, a band for encircling a body part includes a strip of substantially non-stretchable material having a length substantially greater than a width and a single weakened region comprising a removable strip of the band that is oriented across the band. The strip of substantially non-stretchable material has a length substantially greater than a width and two ends having associated therewith one or more closure mechanisms to securely attach the two ends together about the body part. It also has first and second side edges. The removable strip is at least partially defined by a pair of lines of weakness separated by a gap of between about 2 and about 15 mm.

In another aspect of the invention, a method of using such a band includes the steps of encircling a body part with the band, securely attaching the two ends together to encircle the body part in a manner to resist removal of the band in an undamaged manner, and after use, gripping the removable strip of the first side edge of the band and pulling the removable strip to fracture the band along the lines of weakness and to separate the removable strip from the band and removing the band from about the body part.

### BRIEF DESCRIPTION OF THE DRAWINGS

Embodiments of this invention will now be described in greater detail, by way of illustration only, with reference to the accompanying drawings, in which

FIG. 1 is a perspective view of a band according to one embodiment of the present invention.

FIG. 2 is a top plan view of the band of FIG. 1.

FIG. 2a is an enlarged portion of the band of FIG. 1.

FIG. 3 is a top plan view of a second embodiment of an elongate adhesive article of the present invention.

FIG. 3a is an enlarged portion of the band of FIG. 3.

FIGS. 4-6 are a representation of the removal of one embodiment of a wristband according to one aspect of the present invention.

### DETAILED DESCRIPTION OF THE INVENTION

Again, bands, including wristbands (or bracelets) and anklets that securely fasten around human and other animal body parts are often difficult to remove, especially when they are applied around wrists and ankles. Therefore, we have provided novel bands that are easily removable from around body parts without causing excessive pain.

As used in the specification and claims, the term “band” and variants thereof relate to a thin strip of flexible material that is used to encircle an object. Generally, the bands are for use in identification (e.g., with personal information for a hospital patient) or to indicate admission (e.g., for an amusement park).

As used in the specification and claims, the term “non-stretchable” and variants thereof relate to materials having a low degree of elongation under normal use and even expected abuse conditions. In particular, non-stretchable relates to a strip of material that may be formed into a secured band fitting snugly about a body part, such as a wrist, that cannot stretch sufficiently to be pulled over an associated hand to remove the band without destruction and/or obvious damage to the band.

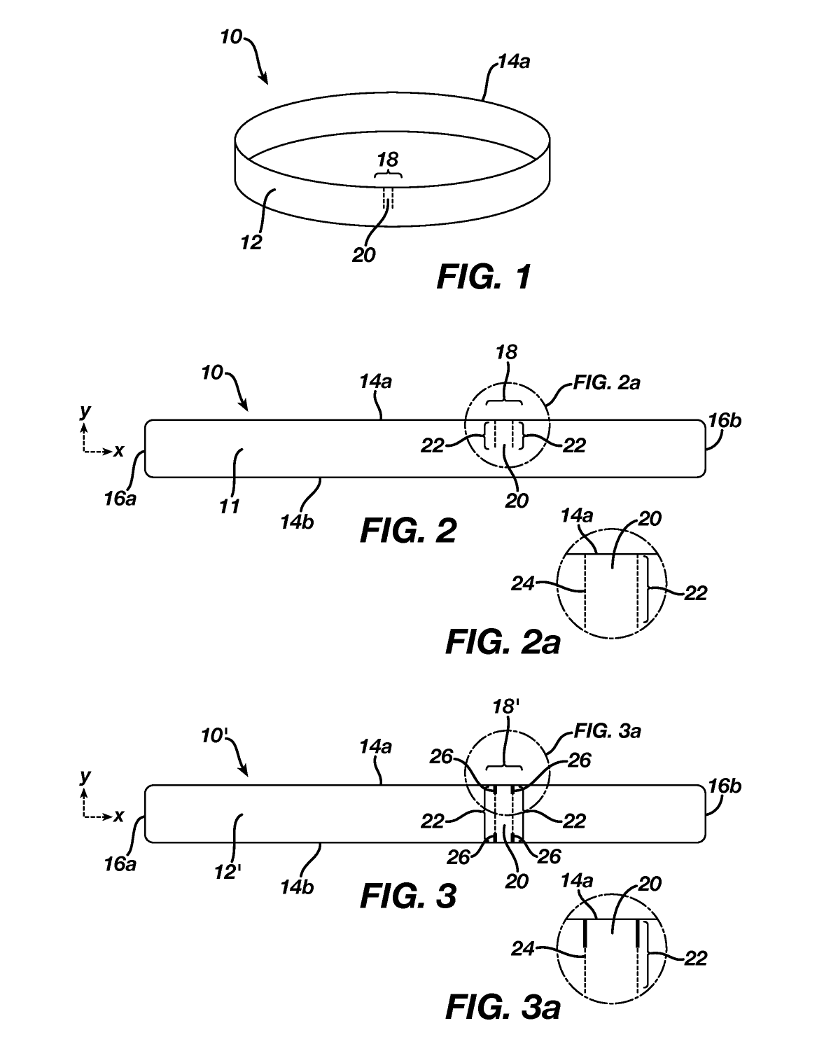

FIGS. 1 and 2 illustrate a first embodiment of a band of the present invention. The band 10 comprises strip 12 of flexible material that can be fastened about a body part, such as a wrist or ankle, and that can be easily removed by fracturing the band. The strip 12 has a length substantially greater than a width and first side edge 14a, second side edge 14b, and first and second ends 16a, 16b arranged and configured for substantially permanent connection. Band 10 has a single weakened region 18 comprising a removable strip 20 of the band material that is oriented substantially perpendicular to the article length. The removable strip 20 is at least partially defined by a pair of lines of weakness 22 which originate from first side edge 14a, and are generally disposed across the width of the band. To aid in the removal of the band 10 from an element about which it is secured, a user would fracture the lines of weakness 22 starting from first side edge 14a, along their length (across the width of the band, the “y-axis”), and remove the strip 20 in the region between the liens of weakness 22. The user can then remove the remainder of the band from about the body part.

Band 10 may have various modifications to a simple strip, including but not limited to, widened and/or narrowed regions, tabs extending generally perpendicularly away from the band, etc. In general, the thickness of band material is between about 0.02 to about 0.2 millimeter (“mm”) to achieve the desired flexing characteristics.

Again, preferred band material may be thin and highly flexible, and substantially non-stretchable. Thus, the band permits free movement of the body part wearing the product, but it is not removable without obviously damaging the band. The band may be clear or opaque, and may include a woven or nonwoven fabric, a polymeric film or reinforced paper. The band may be formed of a single layer of material or it may be a laminate or other combination of materials. Polymeric materials useful in forming the band are known to those of ordinary skill in the art. They include polyesters, polystyrenes, polyolefin (such as polyethylene), polyurethane, polyvinylchloride. Currently used commercial products that are substantially non-stretchable include paper wristbands manufactured from TYVEK® brand paper materials and vinyl wristbands.

In one preferred embodiment, the band 10 comprises a strip of woven fabric having either a warp or weft oriented substantially across the width of the elongate article. Thus a tear propagated across the band will tend to continue until the article is separated by removal of the removable strip 20. In another embodiment, the band comprises a strip of an oriented polymer in which a tear propagated across the band will tend to continue until the article is again separated by removal of the removable strip 20.

Again, the length of the strip 12 forming the band 10 is substantially greater than the width. Preferably, the width of the band is at least about 10 mm, more preferably at least about 15 mm or at least about 20 mm. In a preferred embodiment, the width of band is less than about 100 mm, more preferably, less than about 70 mm, and most preferably, less than about 40 mm. Thus, the width of band may be between about 10 mm and 100 mm, preferably between about 15 mm and 70 mm, more preferably between about 20 mm and 40 mm. In one embodiment the width of band is about 25 mm.

Band 10 has a single weakened region 18 at least partially defined by two lines of weakness 22 which originate proximate the first side edge 14a, and are generally disposed across the band. The resulting removable strip 20 has a width (defined by the maximum distance between the two lines of weakness 22) between about 2 mm and 15 mm, preferably between about 2 mm and 10 mm, more preferably between about 2 mm and 6 mm, and most preferably about 4 mm.

The lines of weakness 22 may be defined by scoring, a thinning of the backing layer from its original thickness, perforating, or other weakening methods known to those of ordinary skill in the art. In some embodiments, at least one of the two lines of weakness 22 may be scored, while the other line of weakness 22 includes a plurality of discontinuous weakness elements 24 that are fully perforated (as shown in the enlarged view of FIG. 2a).

Preferably, the lines of weakness 22 are substantially parallel. However, it may be acceptable for the lines to converge or diverge as long as they provide a removable strip 20.

Weakness elements 24 may be any shape, including circular, elliptical, linear, arrow- or V-shaped, Y-shaped, S-shaped, chevron, a partial-chevron, and a dot pattern. In some embodiments, a simple linear pattern of linear cuts is used, in which the cuts are aligned to create a single, broken separation line that extends laterally across the band 10.

In some embodiments, the weakness elements are of equal length. The length of the weakness elements may range from about 0.1 mm to about 5 mm, alternatively from about 0.25 mm to about 3 mm, or even from about 0.5 mm to about 1 mm. The gap between weakness elements may be uniform or variable. The gap between the weakness elements may range from about 0.1 mm to about 5 mm, preferably, from about 0.25 mm to about 3 mm, and most preferably, between about 0.5 mm and about 1 mm.

The sizes of weakness elements 24 and the distance between them help to determine the force required to tear and remove the removable strip 20.

As shown in FIG. 1, the lines of weakness 22 originate from first side edge 14a, are generally disposed along the y-axis, and terminate at point between first side edge 14a and second side edge 14b. As shown in the figure, the lines of weakness 22 span approximately half (50%) of the width of the backing layer. It is to be understood that in various embodiments, lines of weakness 22 may span substantially all of the width of the band, or some amount less than the width of the band. In one preferred embodiment, the lines of weakness span about 75% of the width. In another embodiment, the lines of weakness span about 33% or even 25% of the width of the band.

FIG. 1 also shows lines of weakness 22 originating at first side edge 14a. It is to be understood that in other embodiments, lines of weakness 22 may originate at a point part way between first side edge 14a and second side edge 14b. For example, the lines of weakness may be spaced in slightly, such as between about 1% and about 5% of the band width, from the side edges to prevent undesired premature removal of the removable strip. In another embodiment, the lines of weakness may be spaced at a greater distance from the side edge; perhaps as much as 10% to 20% of the band width.

FIG. 3 illustrates a second embodiment of a band of the present invention. The band 20′ again comprises strip 12′ of flexible material. The strip 12′ has a length substantially greater than a width and first side edge 14a, second side edge 14b, and first and second ends 16a, 16b arranged and configured for substantially permanent connection. Band 10′ has a single weakened region 18′ comprising a removable strip 20 of the band material that is oriented substantially perpendicular to the article length. The removable strip is at least partially defined by a pair of lines of weakness 22 comprising weakness elements 24 and two pair of slits 26 that originate from the first side edge 14a and the second side edge 14b. In this embodiment, the weakness elements 24 and slits 26 result in a removable strip 20 clearly defined across the band 10.

To remove the band 10′, a user would lift an edge of the removable strip 20 starting between one pair of slits 26 using for example, a finger nail. In this manner, the pair of slits 26 acts as a “pick point”, or “starting point”. User would then fracture the lines of weakness 22 starting from one side edge, e.g., first side edge 14a, across the band 10, and remove the removable strip 20. The remainder of the band can then be removed from about the body part if it does not come free with the removable strip 20.

As shown in FIG. 3, lines of weakness 22 terminate proximate second side edge 14b. It is to be understood that, as in the embodiments relating to FIGS. 1 and 2, above, lines of weakness 22 may span all or part of the width of the band.

As shown in FIG. 3 and the detailed view of FIG. 3a, the slits 26 that define the “pick point” of the removable strip 20 originate at both side edges 14a, 14b. It is to be understood that in other embodiments, slits 26 may also originate at only one side edge, e.g., first side edge 14a of band 10.

Slits 26 may be any shape, including circular, elliptical, linear, arrow- or V-shaped, Y-shaped, S-shaped, chevron, or partial-chevron. In some embodiments, a simple linear pattern of slits is used, in which the slits are aligned to create a single, broken separation line that extends laterally across the band 10. Slits 26 may be perpendicular to the side edge 14a of the backing material or they may be arranged at an angle other than 90°. However, the lines of weakness 22 associated with such angled slits are preferably substantially perpendicular.

In some embodiments, slits 26 are of equal length. The length of the slits may range from about 0.1 mm to about 5 mm, preferably from about 0.25 mm to about 3 mm. If it is desired to minimize the length of the slit and to reduce the likelihood of premature removal of the removal strip, one may desire to limit the slit to a length of between about 0.5 mm and about 1 mm.

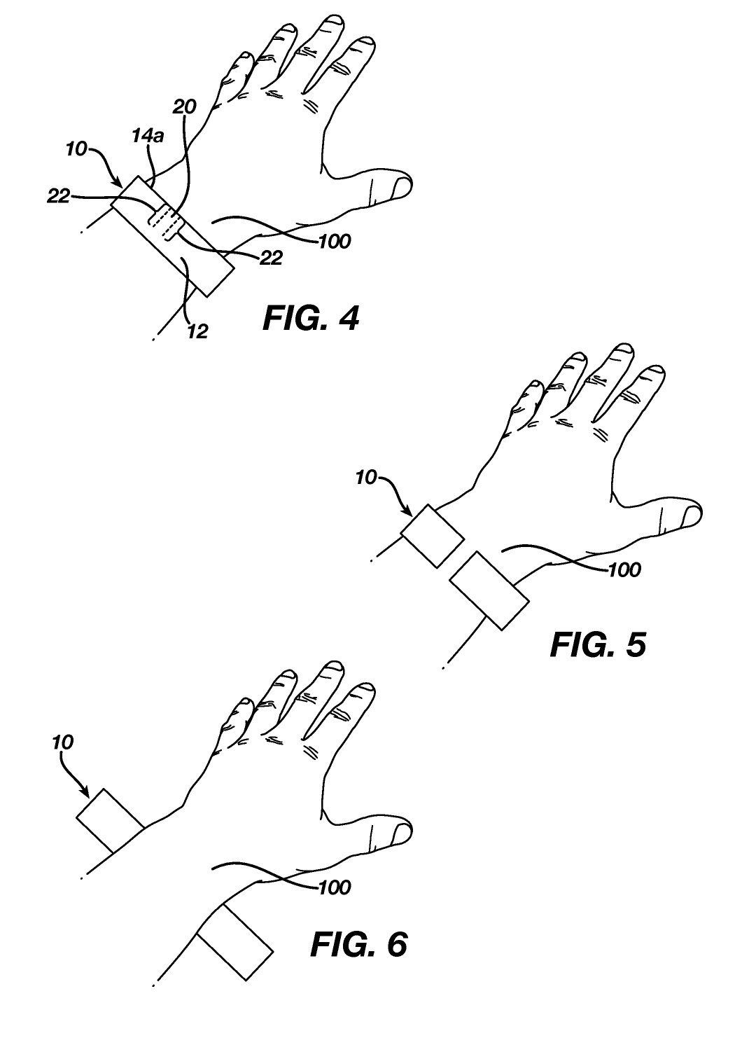

FIGS. 4 to 6 are a representation of the use of an embodiment of the band of FIGS. 1 and 2. The user encircles the body part, such as a human wrist 100, with the non-stretchable strip 12 of material and securely attaches the two ends 16a, 16b together. This forms a flexible band 10 that is nonetheless sufficiently dimensionally stable to substantially prevent removal from the wrist without damage to the band 10. Thus, it is difficult to remove the band from one individual and share it with another. After use, the user can gripping the removable strip 20 at the first side edge 14a of the band 10 and pull on the removable strip 20 to fracture the band 10 along the lines of weakness 22 and to separate the removable strip 20 from the band 10. In the event that the lines of weakness 22 do not extend fully across the band 10, the material forming the band would be selected to encourage a tear propagated along the lines of weakness 22 to continue completely across the band 10. Removing the removable strip 20 may directly result in the removal of the band 10 from about the wrist (or other body part). For example, a small portion of the removable strip 20 may remain attached on only one side to the remainder of the band 10 and pull the removing band from about the body part. Otherwise, the removal of the strip 20 results in a gap of the band 10 about the wrist, permitting removal therefrom.

The process of manufacturing the bands described above may be any of those conventionally known to produce identification and/or security bands. The strip of non-stretchable material can be formed as a laminate with an adhesive to permit the ends of the strip to be securely fastened about the body part in use. Alternatively, the strip of non-stretchable material may have closure elements formed at or attached to the ends of the strip. The strips of non-stretchable material may therefore be provided in roll form for removal of individual band-forming strips prior to use. The strips of non-stretchable material may also be provided as separate band-forming strips.

The lines of weakness described above may be formed by a variety of manufacturing processes. In some embodiments, mechanical punches may be employed to perforate the materials. Hot pin perforation, also known in the prior art, may be used in the manufacturing process. Kiss cutting and die cutting are also known processes that may be employed to perforate, slit, and/or score.

Ultrasonic perforation is also employed in the prior art. Ultrasonic systems employ ultrasonic equipment adjacent to a pin roll with a fixed gap of space in the path of the web between the ultrasonic equipment and the pin roll. In one embodiment, the ultrasonic system includes a nip roll for providing tension to the web, a pin roll constructed of hardened and/or unhardened steel and a wear resistant coating, and an ultrasonic horn, which is cooled by a stream of forced air. The ultrasonic horn and pin roll are preferably positioned so that there is no gap between the two, and no calibration or extremely precise machining of the pin roll is required. The method of the invention includes holding the web in tension, perforating the web with ultrasonic equipment which is immediately adjacent to a pin roll, and cooling the ultrasonic equipment with a forced stream of air. The resulting material has well defined holes without abnormal tearing, and has a smooth surface with no raised annular edges around the holes.

While various embodiments of the invention have been set forth above, it will be apparent to those skilled in the art that various modifications and variations can be made in the present invention without departing from the scope or spirit of the invention. Thus, it is intended that the present invention cover such modifications and variations as come within the scope of the appended claims and their equivalents.

1. A band for encircling a body part, the band comprising:
a) a strip of substantially non-stretchable material having a length substantially greater than a width and two ends having associated therewith one or more closure mechanisms to securely attach the two ends together about the body part, the strip having a thickness, and first and second side edges; and
b) a single weakened region comprising a removable strip of the band that is oriented across the band; wherein the removable strip of is at least partially defined by a pair of lines of weakness separated by a gap of between about 2 and about 15 mm and wherein the removable strip is arranged and configured to fracture the band along the lines of weakness.

2. The band of claim 1, wherein the pair of lines of weakness is separated by a gap of between about 2 and about 6 mm.

3. The band of claim 1, wherein the pair of lines of weakness extends from the first side edge toward the second side edge.

4. The band of claim 1, wherein the pair of lines of weakness spans substantially all of the width of the article.

5. The band of claim 1, wherein at least one of the lines of weakness span comprises perforations.

6. The band of claim 1, wherein at least one of the lines of weakness span comprises a reduction in the thickness of the band.

7. The band of claim 1 wherein at least one of the lines of weakness comprises a slit proximate the first side edge.

8. The article of claim 7 wherein the slit is oriented substantially perpendicular to the first side edge.

9. The band of claim 1 wherein the removable strip is oriented substantially perpendicular to the band.

10. The band of claim 9 wherein lines of weakness are substantially parallel.

11. A method of using the band of claim 1 comprising the steps of:
a) encircling a body part with the band;
b) securely attaching the two ends together to encircle the body part in a manner to resist removal of the band in an undamaged manner;
c) gripping the removable strip of the first side edge of the band and pulling the removable strip to fracture the band along the lines of weakness and to separate the removable strip from the band; and
c) removing the band from about the body part.

12. The method of claim 11, wherein the body part is a human ankle or wrist.
